(19) United States
(12) Patent Application Publication
(10) Pub. No.: US 2026/0330852 A1
(43) Pub. Date: Oct. 22, 2026

(54) GRAPHRAG ENHANCEMENT WITH MACHINE LEARNING MODEL-BASED IMAGE SEGMENTATION AND DETECTION

(71) Applicants: Constructor Technology AG, Schaffhausen (CH); Constructor Education and Research Genossenschaft, Schaffhausen (CH)

(72) Inventors: Alexander Tormasov, Bremen (DE); Andrey Adashchik, Istanbul (TR); Sergey Ulasen, Singapore (SG); Serg Bell, Singapore (SG); Stanislav Protasov, Singapore (SG); Nikolay Dobrovolskiy, Alanya (TR); Laurent Dedenis, Geneve (CH)

(21) Appl. No.: 19/182,703

(22) Filed: Apr. 18, 2025

(51) Int. Cl. G06V 20/70; G06F 16/43; G06V 10/25; G06V 10/82

(52) U.S. Cl. CPC G06V 20/70; G06F 16/43; G06V 10/25; G06V 10/82

(57) ABSTRACT

Disclosed herein are systems and methods for associating digital images and text. The method includes: obtaining a digital image and text; analyzing the digital image using an image segmentation MLM trained to identify a plurality of distinct graphical elements in the digital image and to generate a plurality of image segments; splitting the text associated with the digital image using a text segmentation MLM into a plurality of text chunks; analyzing the plurality of image segments and the plurality of text chunks using the text segmentation MLM to identify semantic links between related text chunks and image segments that describe and depict, respectively, the same one or more district graphic elements; and storing into a multimodal database the digital image, the plurality of image segments, the plurality of text chunks, and the semantic links between the related text chunks and image segments.

### FIELD OF TECHNOLOGY

The present disclosure relates to the field of machine learning, and, more specifically, to systems and methods for implementing an advanced Retrieval-Augmented Generation (RAG) system for integrating digital images, image segments, and text connections.

### BACKGROUND

Retrieval-Augmented Generation (RAG) systems primarily process images as whole entities without linking them to relevant text, creating significant limitations in contexts where images contain essential information. Many technical documents, such as manuals, patents, and research papers, may include labeled images (e.g., diagrams) with numbered annotations that correspond to textual descriptions. However, existing RAG models lack the ability to segment images into meaningful components and associate them with specific text references. As a result, users querying for a particular visual element—such as a specific part in an exploded view—often receive incomplete or irrelevant results, as the system cannot establish contextual relationships between text and image segments. Furthermore, the absence of a structured mapping between text and images makes it difficult to verify consistency between labeled elements in diagrams and their corresponding textual explanations, a crucial requirement in fields like patent validation and engineering documentation. Without an integrated approach that connects image segmentation, text chunking, and structured linking, AI-powered retrieval remains inefficient, limiting its effectiveness in technical and knowledge-intensive applications.

### SUMMARY

To associate image segments and text descriptions using RAG systems, the present disclosure describes implementing an enhanced RAG system by creating structured links between digital images, their image segments, and relevant text chunks. The present disclosure describes analyzing a digital image using a MLM to identify a plurality of distinct graphical elements in the digital image. In another aspect, the present disclosure describes utilizing another MLM to analyze the text and identify links between textual descriptions and image segments. The digital images, image segments, and text chunks are then associated and stored in a multimodal database for efficient retrieval. Accordingly, the present disclosure describes a retrieval engine to process queries by matching text references to corresponding image segments and descriptions.

In one exemplary aspect, a method for associating digital images and text is disclosed. The method includes: obtaining a digital image and text associated with the digital image; analyzing the digital image using an image segmentation machine learning model (MLM) trained to identify a plurality of distinct graphical elements in the digital image and to generate a plurality of image segments each depicting at least one distinct graphical element; splitting the text associated with the digital image using a text segmentation MLM into a plurality of text chunks each describing at least one distinct graphical element of the digital image; analyzing the plurality of image segments and the plurality of text chunks using the text segmentation MLM to identify semantic links between related text chunks and image segments that describe and depict, respectively, the same one or more district graphic elements; and storing into a multimodal database the digital image, the plurality of image segments, the plurality of text chunks, and the semantic links between the related text chunks and image segments.

In some aspects, the techniques described herein relate to a method, further comprising: generating text descriptions of the digital image and the image segments using a LLM; and storing the text descriptions of the digital image and the image segments in the multimodal database.

In some aspects, the techniques described herein relate to a method, wherein the multimodal database is used by a retrieval-augmented generation (RAG) LLM.

In some aspects, the techniques described herein relate to a method, further comprising: receiving an input query to a LLM service from a user; transmitting a prompt based on the input query to the LLM service; obtaining a response from the LLM service by utilizing an image association MLM to identify an image segment associated with the text chunks in the multimodal database and corresponding image for the identified image segment; annotating the identified image segment associated with the text chunk; and display the response comprising the corresponding image with the annotated image segment.

In some aspects, the techniques described herein relate to a method, further comprising: obtaining a validation digital image containing reference numbers and text; generating validation image segments from the reference image using the image segmentation MLM; splitting the text associated with the validation image into text phrases and associating the text phrases to a respective validation image segment using the text segmentation MLM; storing the validation image, the validation image segments, the text phrases, and the semantic links between the text phrases, corresponding validation image segments, and the validation image into the multimodal database of a RAG system; obtaining an input query checking for inconsistencies in reference numbers in the validation image and the text to a LLM service; transmitting a prompt based on the input query to the LLM service; obtaining a response from the LLM service by utilizing an image LLM to identify an image segment associated with the text in the multimodal database and corresponding image for the identified image segment; comparing the response from the LLM service with the text phrases generated from the text segmentation MLM; and displaying results of the comparison between the response from the LLM service with the text phrases generated from the text segmentation MLM.

In some aspects, the techniques described herein relate to a method, further comprising: training the image segmentation MLM by: (1) providing, to the image segmentation MLM, an image segmentation training dataset comprising at least one of: (a) training images labeled and annotated with multiple image segments, and (b) ground truth labels for the training images to serve as a target output for the image segmentation MLM, and (2) preparing the image segmentation MLM using the provided image segmentation training dataset.

In some aspects, the techniques described herein relate to a method, further comprising: training the text segmentation MLM by: (1) providing, to the text segmentation MLM, a text segmentation training dataset comprising at least one of: (a) training data labeled and annotated with text input segmented into text phrases and linked to specific image segments, (b) corresponding image data segmented into image segments that match the text phrases, and (c) ground truth labels for the training data and corresponding image data to serve as a phrase-segment mapping for the text segmentation MLM, and (2) preparing the text segmentation MLM using the provided text segmentation training dataset.

In some aspects, the techniques described herein relate to a method, further comprising: training the image association MLM by: (1) providing, to the image association MLM, an image association training dataset comprising at least one of: (a) training images with image segments of regions of interests such that the image segments are labeled with text annotations describing what the image segment represents, (b) paired image-segment-text data to teach the image association MLM the relationship between image segments and the text annotations, and (c) ground truth labels for the training images and paired image-segment-text data to serve as a target output for the image association MLM, and (2) preparing the image association MLM using the provided image association training dataset.

According to one aspect of the disclosure, a system is provided for associating digital images and text, the system including: at least one memory; and at least one hardware processor coupled with the at least one memory and configured, individually or in combination, to: obtain a digital image and text associated with the digital image; analyze the digital image using an image segmentation machine learning model (MLM) trained to identify a plurality of distinct graphical elements in the digital image and to generate a plurality of image segments each depicting at least one distinct graphical element; split the text associated with the digital image using a text segmentation MLM into a plurality of text chunks each describing at least one distinct graphical element of the digital image; analyze the plurality of image segments and the plurality of text chunks using the text segmentation MLM to identify semantic links between related text chunks and image segments that describe and depict, respectively, the same one or more district graphic elements; and store into a multimodal database the digital image, the plurality of image segments, the plurality of text chunks, and the semantic links between the related text chunks and image segments.

In one exemplary aspect, a non-transitory computer-readable medium is provided storing a set of instructions thereon for associating digital images and text, the system, including instructions for: obtaining a digital image and text associated with the digital image; analyzing the digital image using an image segmentation machine learning model (MLM) trained to identify a plurality of distinct graphical elements in the digital image and to generate a plurality of image segments each depicting at least one distinct graphical element; splitting the text associated with the digital image using a text segmentation MLM into a plurality of text chunks each describing at least one distinct graphical element of the digital image; analyzing the plurality of image segments and the plurality of text chunks using the text segmentation MLM to identify semantic links between related text chunks and image segments that describe and depict, respectively, the same one or more district graphic elements; and storing into a multimodal database the digital image, the plurality of image segments, the plurality of text chunks, and the semantic links between the related text chunks and image segments.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for associating digital images and texts according to aspects of the present disclosure.

FIG. 2 is a block diagram illustrating a system for preparing machine learning models to generate image segments each depicting a distinct graphical element and identifying semantic links between related text chunks and image segments according to aspects of the present disclosure.

FIG. 3 is an example flowchart for creating structured links between digital images, their image segments, and relevant text chunks according to aspects of the present disclosure.

FIG. 4a is an example of a digital image with identified plurality of distinct graphical elements according to aspects of the present disclosure.

FIG. 4b is an example of text corresponding to a digital image split into text chunks describing a graphical element of the digital image according to aspects of the present disclosure.

FIG. 4c is an example of identifying semantic links between related text chunks and image segments according to aspects of the present disclosure.

FIG. 5 is an example method for associating digital images and text according to an aspect of the present disclosure.

FIG. 6 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for associating digital images and text by identifying semantic links between text chunks from the text and image segments from the digital images. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Retrieval-Augmented Generation (RAG) systems combine the strengths of information retrieval and generative artificial intelligence (AI) to enhance the accuracy and relevance of responses in AI-driven applications. Unlike traditional language models that generate answers based solely on their pre-trained knowledge, RAG systems retrieve external documents or data relevant to a query before generating a response. This approach ensures that the model's outputs are informed by up-to-date and domain-specific information, making RAG particularly useful in fields like technical documentation, research, customer support, and legal analysis. By integrating retrieval mechanisms with large language models (LLMs), RAG systems improve factual accuracy, reduce hallucinations, and provide more contextually relevant responses, making them a powerful tool for knowledge-intensive applications.

In the field of RAG systems, AI models are primarily designed to retrieve and generate text-based responses based on structured knowledge sources. However, a significant limitation of existing RAG systems is their inability to effectively process and associate images with textual descriptions in a meaningful way. Many technical and scientific documents, such as instruction manuals, patent applications, and research papers, contain complex diagrams, illustrations, and labeled images that are closely tied to the surrounding text. While these images often contain numbered references that correspond to specific text descriptions, current AI retrieval models fail to establish structured links between these elements. This creates a challenge for users who need to query specific components within an image based on textual references, as the system lacks the capability to map the relationships between image fragments and their corresponding descriptions.

The existing RAG systems treat images as a whole, without breaking them down into distinct, identifiable segments that can be linked to relevant text. Consequently, when users attempt to query an element that is visually represented within an image but described in the text, they often receive irrelevant or incomplete results. For example, in a technical manual for a coffee machine, a user might want to locate a particular component, such as “switch 5,” by referring to a numbered image annotation. In current AI-driven retrieval systems, this would be nearly impossible, as there is no structured mechanism to connect the textual reference to the exact segment of the image where the switch is illustrated. This limitation also extends to verification tasks, such as ensuring that all numbered elements in an image correctly correspond to the descriptions in the text, which is critical in fields like patent validation and scientific documentation.

To address these issues, the present disclosure introduces a RAG system enhanced with picture-segment-text connections to create a structured mapping between images, their segmented components, and relevant text. A first aspect of the present disclosure describes segmenting digital images into distinct parts and assigning unique identifiers to each element. A second aspect of the present disclosure describes processing text associated with the digital image to extract meaningful references to image elements. A third aspect of the present disclosure describes storing relationships between text chunks and image segments in a multimodal database for enabling efficient structured retrieval. In this way, the present disclosure allows users to query specific image components using natural language references linked to corresponding textual descriptions.

The technical benefit of the present disclosure introduces significant technical advancements that enhance the accuracy, efficiency, and usability of AI-driven retrieval systems. Unlike traditional RAG models that process images as whole entities, the present disclosure segments digital images into distinct elements and establishes structured links between image fragments and corresponding text chunks using a multimodal database. This structured mapping enables precise retrieval of specific image components based on textual queries, allowing users to locate visual elements such as a numbered part in a technical diagram with ease. Additionally, the system also leverages machine learning models (MLMs) to analyze text and identify semantic links to image segments, enabling contextually aware search and retrieval. This approach significantly improves knowledge retrieval in complex documents such as technical manuals, patents, and scientific articles, where both detailed illustrations and textual explanations must be cross-referenced efficiently.

Moreover, the system can automatically invalidate inconsistencies between image annotations and textual references, making it highly valuable for documentation quality control, patent verification, and technical writing. The adaptable nature of this system also allows it to scale across various domains, including medical images, engineering blueprints, and legal documentation, providing structured, intelligent retrieval that enhances AI-powered search capabilities. By integrating image segmentation, text processing, and structured retrieval, the present disclosure makes AI-driven knowledge models more accurate, context-aware, and efficient, ultimately improving search precision, information validation, and overall user experience.

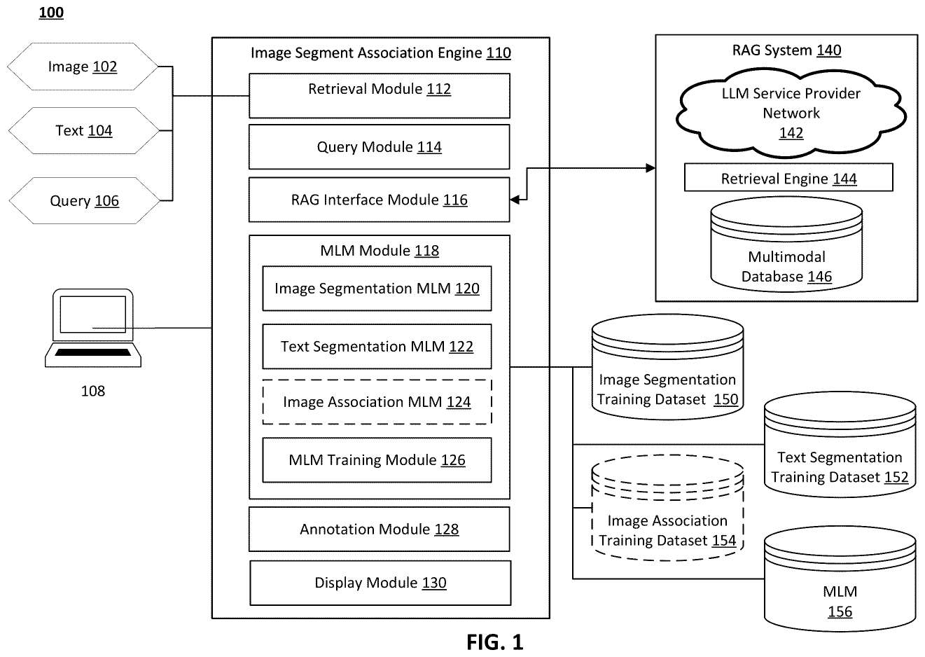

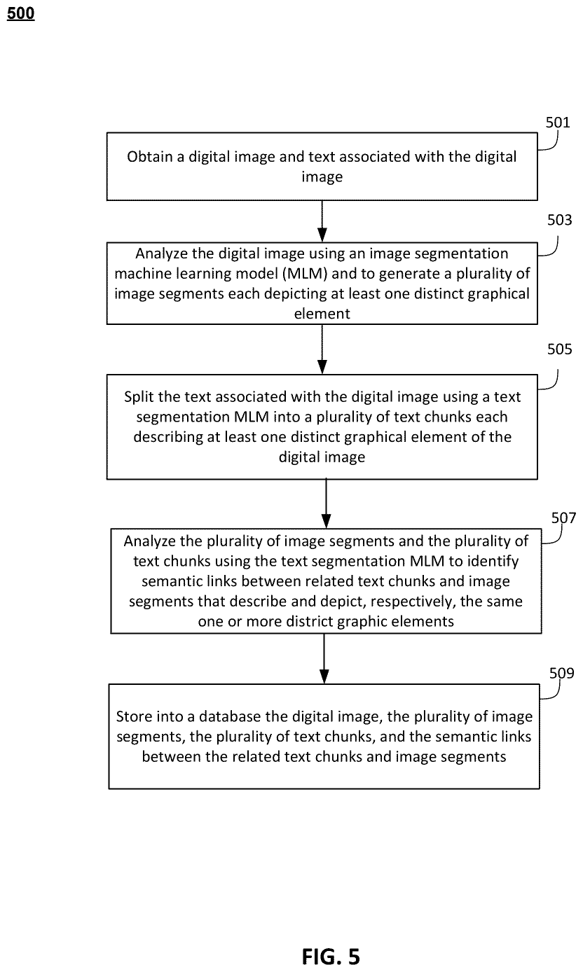

FIG. 1 is a block diagram illustrating a system for associating digital images and text. In one aspect, the components of system 100 may be implemented on computer systems, such as that shown in FIG. 5.

The system 100 may be used to enhance RAG systems 140 by creating structured links between digital images 102, their image segments, and relevant text chunks describing at least one distinct graphical element of the digital image from text 104. Specifically, the image segment association engine 110 is configured to analyze and segment the digital images 102 to identify distinct graphical elements and generate image segments each depicting at least one distinct graphical elements. In addition, the image segment association engine 110 is configured to split the text 104 associated with the digital image 102 into a plurality of text chunks describing the distinct graphical element. The image segment association engine 110 is configured to analyze the image segments and text chunks to identify semantic links between related text chunks and image segments. Furthermore, the image segment association engine 110 is configured to prepare text descriptions of the digital image and each image segments for storage in a multimodal database 146 in the RAG system 140. In this way, the image segment association engine 110 may process queries by matching text references to corresponding image segments and descriptions by querying, via a retrieval engine 144, the multimodal database 146 in the RAG system 140.

A RAG system 140 is an advanced AI framework that enhances the capabilities of a LLM from a LLM service provider network 142 by integrating real-time information retrieval from the multimodal database 146 via the retrieval engine 144. Unlike standalone LLMs, which generate responses based solely on their pre-trained knowledge, RAG systems dynamically fetch relevant documents or data from external sources to ground their outputs in up-to-date and contextually accurate information. This retrieval process helps improve response accuracy, reduce hallucinations, and extend the model's knowledge beyond its training data, making RAG systems particularly effective for tasks requiring factual precision and domain-specific insights.

The system 100 includes at least digital images 102, a text 104 corresponding to the digital images 102, a query 106, a computing device 108, an image segment association engine 110, the RAG system 140 comprising access to a LLM service provider network 142, and various databases (e.g., an image segmentation training dataset 150, a text segmentation training dataset 152, an optional image association training database 154, and a MLM database 156). The image segment association engine 110 is configured to enhance the functionality of the RAG system 140 by associating and creating structured links between the digital images 102, their segmented image components, and relevant text descriptions from the text 104.

By integrating the image segment association engine 110 with the RAG system 140, the system 100 ensures that queries 106 can be answered with precise visual and textual references, improving the accuracy and depth of responses to the LLM from the LLM service provider network 142. The computing device 108 may execute a plurality of modules in the image segment association engine 110 that together make up the collection, analysis, identification, and retrieval system. In some aspects, the image segment association engine 110 may correspond to the computing device 108 or cloud network (not shown) that is configured to execute a plurality of modules that make up the image segment association engine 110.

In some aspects, the image segment association engine 110 may include a retrieval module 112, a query module 114, a RAG interface module 116, a MLM module 118 including at least an image segmentation MLM 120, a text segmentation MLM 122, an optional image association MLM 124, and a MLM training module 126, an annotation module 128, and a display module 130. In some aspects, the training data for the MLM training module 126 may be obtained from the image segmentation training dataset 150, the text segmentation training dataset 152, and/or the optional image association training dataset 154. In some aspects, the image segmentation MLM 120, the text segmentation MLM 122, and the optional image association MLM 124 may be stored on the MLM database 156.

In some aspects, the computing device 108 may execute a retrieval module 112 to retrieve the digital image 102, the text 104 associated with the digital image 102, and/or a query 106. In some aspects, the digital image 102 may be associated with the text 104. As an example, the text 104 may correspond to an instruction book for a coffee machine and includes images 102 of the coffee machine in both an assembled and disassembled state such that each part of the coffee machine may be a distinct graphical element. Specifically, each fragment of the dissembled image is dedicated to an important element such as a pipe or a switch and may have an arrow with a reference number assigned to it. The text 104 following the digital image 102 explains how the coffee machine works with references to the reference numbers.

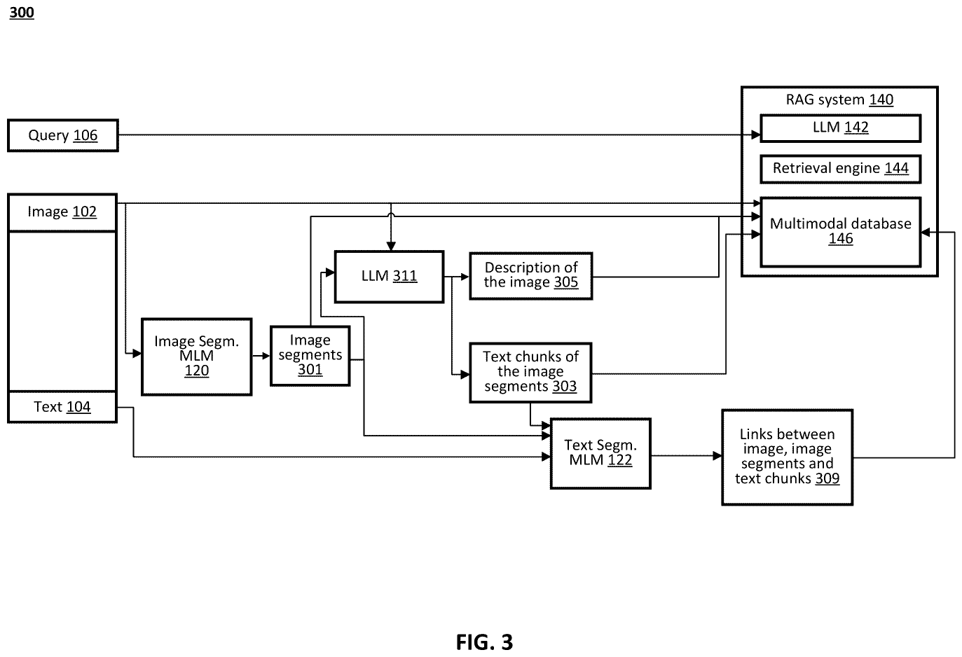

In some aspects, the computing device 108 may execute a query module 114 to obtain a query (e.g., query 106 from FIG. 3) from a computing device 108 of a user. Generally, the query module 114 is configured to act as an intermediary layer in the RAG system 140 and/or LLM-based systems by enhancing a LLM model's ability to understand, interpret, and respond to user queries effectively. Specifically, the query module 114 may be configured to handle and interpret the query 106 and generate a prompt from the query 106 that is formatted in a way that the LLM from the LLM service provider network 142 can process. The primary role of the query module 114 is to bridge the gap between raw user input from the computing device 108 and the LLM service provider network 142. In some aspects, the query module 114 may be equipped with natural language understanding for analyzing and interpreting the query to understand its intent, context, and meaning.

As an example, the user may use the computing device 108 to enter the query 106 for input as a prompt into the LLM from the LLM service provider network 142. In some aspects, the query module 114 may prepare the query 106 as a prompt for input into the LLM on the LLM service provider network 142 by cleaning and normalizing the text entered by the user. As a non-limiting example, this may involve removing unnecessary punctuations, special characters, or stop words; correcting spelling or grammatical errors; or converting different forms of data (e.g., dates, numbers, or units) into a standardized format. By identifying the user's intent behind the query (e.g., asking a question, requesting information, or performing a task), the query module 114 ensures that the LLM from the LLM service provider network 142 may determine the appropriate type of response or action. Following the coffee machine example, the query 106 from the user may be “Find me an image of element X (e.g., ‘switch 5’).”

The computing device 108 may execute the RAG interface module 116 to interact with the RAG system 140 and/or the LLM service provider network 142 by transmitting a prompt generated by the query module 114 for input into the LLM from the LLM service provider network 142 and to obtain responses from the LLM service provider network 142. Generally, the RAG interface module 116 is responsible for managing the interactions between the RAG system 140 and modules from the image segment association engine 110. The primary function of the RAG interface module 116 is to handle the exchange of data between the image segment association engine 110 and RAG system 140 including the LLM service provider network 142, the retrieval engine 144 and/or the multimodal database 146 to ensure that the inputs and output of the LLM are effectively communicated to the appropriate destinations. This module serves as the interface layer that facilitates communication to enable the RAG system 140 to integrate into the system 100.

In some aspects, the RAG interface module 116 is configured to provide an API that the image segment association engine 110 utilizes to interact with the LLM service provider network 142, the retrieval engine 144, and/or the multimodal database 146. As a non-limiting example, this may include handling API requests and responses from the LLM service provider network 142, managing authentication and authorization for secure access, or supporting different API protocols (e.g., REST, WebSocket) to accommodate various integration needs.

In some aspects, the RAG interface module 116 is configured to store and organize data (e.g., the digital image 102, the plurality of image segments, the plurality of text chunks from the text 104, and the semantic links between the related text chunks and image segments) into the multimodal database 146. In some aspects, the multimodal database 146 may be graph database. The structure of the graph database allows for efficient retrieval, enabling the system 100 to traverse linked data when a user searches for a specific element (e.g., “Switch 5”) in the digital image 102. Upon query processing, the RAG system 140 retrieves the most relevant text and associated image segment, ensuring accurate and context-aware responses.

As an example, the graph database is a type of database designed to store and manage data in a graph structure, where entities (nodes) and their relationships (edges) are fundamental components. Unlike traditional relational databases rely on use tables and joins, graph databases represent data as interconnected nodes, making them highly efficient for handling complex relationships. Each node represents an entity (e.g., a person, product, or location), while edges define the relationships between them (e.g., “friend of,” “purchased,” or “located in”). Queries in a graph database traverse these relationships directly, enabling fast and flexible data retrieval, which is particularly useful in applications like social networks, fraud detection, and recommendation systems.

Although the present disclosure describes the multimodal database 146 as a graph database, it should be understood that any multimodal database designed to store and manage different types of text such as text, images, audio, video, and structured data may be used. As an on-limiting example, the multimodal database 146 may correspond to document-oriented database, multimodal databases, vector database, time-series databases, relational databases, key-value stores, hybrid databases, or the like.

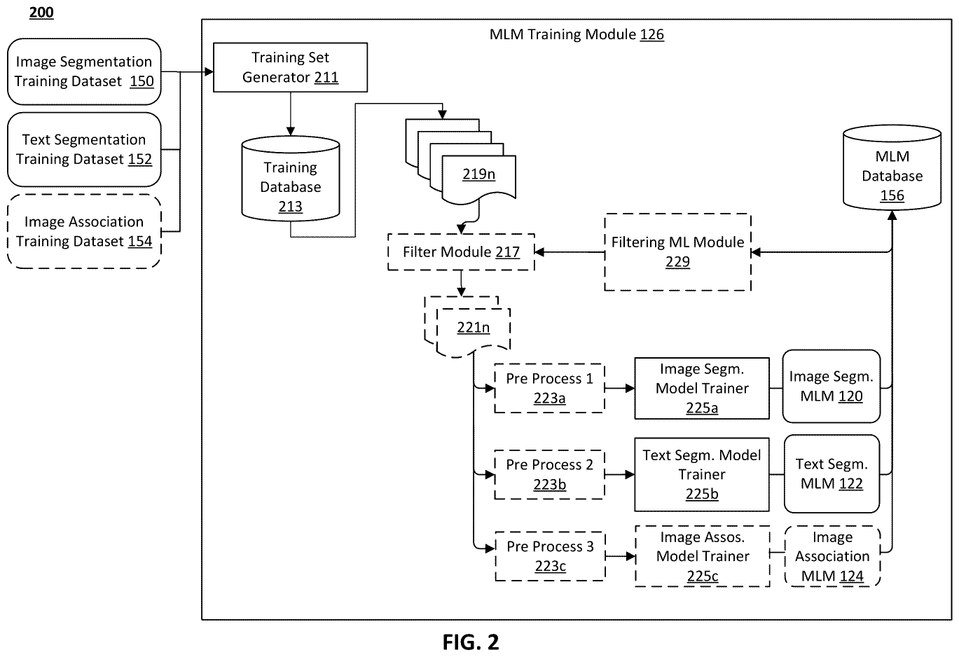

In some aspects, the computing device 108 may execute a MLM module 118 including an image segmentation MLM 120, a text segmentation MLM 122, an optional image association MLM 124, and a MLM training module 126. The image segmentation MLM 120 is configured to identify a plurality of distinct graphical elements in the digital image 102 and to generate a plurality of image segments each depicting at least one distinct graphical element. The text segmentation MLM 122 is configured to identify semantic links between related text chunks and image segments that describe and depict, respectively, the same one or more distinct graphical elements. In some aspects, the text segmentation MLM 122 is also configured to identify semantic links between related text chunks and image segments that describe and depict the same one or more distinct graphic elements by analyzing image segments and the plurality of text chunks. The optional image association MLM 124 is configured to identify an image segment associated with the text chunks stored in the multimodal database 146 and corresponding image for the identified image segment. As will be described in more detail with respect FIG. 2, the MLM training module 126 is configured to train the image segmentation MLM 120, the text segmentation MLM 122, and/or the optional image association MLM 124 and may contain specifically trained MLMs. For illustrative purposes, the present disclosure will describe the MLM as an LLM, but those of ordinary skill in the industry will recognize that any suitable type of MLM may be utilized in the present disclosure.

A LLM is a type of AI designed to understand and generate human language. LLMs are trained on vast amounts of text data, enabling it to perform a wide range of language-related tasks such as answering questions, summarizing text, translating languages, or generating content. LLMS, similar to generative pretrained transformer (GPT), use deep learning techniques to recognize patterns, learn context, and predict word sequences making them highly versatile in natural language processing applications. Accordingly, the computing device 108 may execute the MLM training module 126 to train the MLMs (e.g., LLMs) in the image segmentation MLM 120, the text segmentation MLM 122, and/or the optional image association MLM 124 to teach the MLMs to perform their respective specific tasks. Further details about the training of each respective MLM will be described in further detail in FIG. 2.

A transformer is a deep learning architecture used in LLMs. The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, and image classification and generation. Common examples of transformer models are GPT and Bidirectional Encoder Representations from Transformers (BERT).

The image segmentation MLM 120 is configured to identify distinct graphical elements (e.g., separate parts) in the digital image 102 and to generate a plurality of image segments each depicting at least one distinct graphical element by leveraging machine learning techniques to analyze the digital image 102. The image segmentation MLM 120 is trained on vast corpus of training images from the optional image association training dataset 154, enabling it to develop an ability to identify distinct graphical elements in the digital image 102 and generate image segments containing the distinct graphical element. First, the optional image association training dataset 154 contains similar graphical elements that are labeled and annotated to create segmentation masks that label each distinct element.

In some aspects, preprocessing techniques (e.g., as will be described in the pre process 1 223a, pre process 2 223b, and/or pre process 3 223c in FIG. 2), including resizing, normalization, and data augmentation, enhance the dataset for better generalization. A suitable deep learning model, such as U-Net, DeepLabV3+, or Mask R-CNN, is then selected and trained using frameworks like TensorFlow or PyTorch. The training process may involve using a loss function such as Dice Loss or Categorical Cross-Entropy, optimized with Adam or SGD, while monitoring performance with metrics like IoU and Dice Score. To improve segmentation accuracy, post-processing techniques such as morphological operations, connected component analysis, and Conditional Random Fields (CRF) can be applied. Once trained, the model is deployed using ONNX, TensorFlow Lite, or TorchScript, making it accessible via APIs or embedded systems. The segmented graphical elements can then be extracted using masking techniques, enabling the identification and generation of individual image segments. Continuous improvement is achieved by retraining the model with new data and refining hyperparameters based on performance feedback.

By leveraging supervised or semi-supervised learning techniques, the image segmentation MLM 120 learns to identify distinct graphical elements in the digital images and to generate image segments each depicting at least one distinct graphical element. Once trained, the images segmentation MLM 120 is deployed via an API or embedded into an application for real-time image segmentation. Continuous improvement is ensured by incorporating user feedback and retraining with newly segmented text data to enhance accuracy and generalization.

During inference, the trained image segmentation MLM 120 does not re-evaluate or adjust the layers of the neural network based on the results. Instead, the inference applies knowledge from the trained neural network and uses it to infer a result. Accordingly, when a new unknown dataset (e.g., new digital image) is input through the trained image segmentation MLM 120, the trained image segmentation MLM 120 outputs an image segments each depicting distinct graphical elements by analyzing the digital image based on the predictive accuracy of the MLM.

For other analysis tasks such as splitting the text 104 associated with the digital image 102, an unprepared text segmentation MLM 122 will first analyze data from a text segmentation training dataset 152 to “learn” how to split the text 104 into text chunks each describing at least one distinct graphical element of the digital image 102 and then to identify semantic links between related text chunks and image segments that describe and depict the same distinct graphic elements. The process may begin with analyzing text segmentation training dataset 152 containing images with corresponding textual descriptions. The text segmentation training dataset 152 should be labeled and annotated with text input segmented into text phases and linked to specific image segments and corresponding image data segmented into image segments that match the text phase. The text segmentation training dataset 152 should be annotated to segment descriptions based on distinct graphical elements, which can be achieved manually or using heuristic-based preprocessing (e.g., rule-based NLP techniques).

During training of the text segmentation MLM 122, the results from the untrained MLM are then compared with known training data set results using the corresponding ground truth labels for the training data and corresponding image data to serve as a phase-segment mapping. It should be noted that the input to the trained/prepared text segmentation MLM 122 will be data from the text segmentation training dataset 152. As an example, the text segmentation training dataset 152 may include at least: (a) training images with image segments of regions of interests such that the image segments are labeled with text annotations describing what the image segment represents, (b) paired image-segment-text data to teach the optional image association MLM 124 the relationship between image segments and the text annotations, and (c) ground truth labels for the training images and paired image-segment-text data to serve as a target output for the optional image association MLM 124.

For every input training sample from the text segmentation training dataset 152, the prepared text segmentation MLM 122 will produce a first prediction consisting of values representing a probability that a text chunk describing a distinct graphical element of the digital image 102 should be split from the text 104. In addition, the prepared text segmentation MLM 122 will also produce a second prediction consisting of values representing a probability of semantic links between related text chunks and image segments that correspond to a same distinct graphical element. The output with the highest probability determines the identification. A class label for each answer may be used to compute a loss (e.g., loss function).

The text segmentation MLM 122 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks.

In some aspects, preprocessing steps (e.g., pre process 2 223b shown in FIG. 2), such as tokenization, sentence splitting, and part-of-speech tagging, help structure the data effectively. A suitable deep learning model, such as a transformer-based model (e.g., BERT, T5, or GPT) or a sequence-to-sequence (Seq2Seq) model with attention mechanisms, is then selected and trained using frameworks like TensorFlow or PyTorch. The text segmentation MLM 122 is optimized using loss functions such as cross-entropy loss for sequence classification or contrastive loss for clustering similar segments. Training involves fine-tuning the model using labeled segmentation datasets, leveraging techniques such as self-supervised learning if labeled data is scarce. Post-processing techniques, including Named Entity Recognition (NER) and dependency parsing, can further refine segmentation.

By leveraging supervised or semi-supervised learning techniques, the text segmentation MLM 122 learns to split text associated with a digital image into distinct chunks. Once trained, the text segmentation MLM 122 is deployed via an API or embedded into an application for real-time text segmentation. Continuous improvement is ensured by incorporating user feedback and retraining with newly segmented text data to enhance accuracy and generalization.

During inference, the trained text segmentation MLM 122 does not re-evaluate or adjust the layers of the neural network based on the results. Instead, the inference applies knowledge from the trained neural network and uses it to infer a result. Accordingly, when a new unknown dataset (e.g., text and corresponding image) is input through the trained text segmentation MLM 122, the trained text segmentation MLM 122 outputs a text chunks describing distinct graphical elements by splitting text based on the predictive accuracy of the MLM.

In addition, the trained text segmentation MLM 122 is also trained to identify semantic links between text chunks and image segments that describe and depict the same graphical elements. The process involves obtaining a text segmentation training dataset 152 including images annotated with corresponding text descriptions, ensuring alignment between graphical elements and textual explanations. Preprocessing techniques such as OCR (Optical Character Recognition) for text extraction, tokenization, and semantic parsing help in structuring the text data. Simultaneously, image segmentation is performed using models like U-Net, Mask R-CNN, or DeepLabV3+ to extract distinct graphical elements.

A multimodal learning approach, leveraging transformer-based architectures such as CLIP (Contrastive Language-Image Pretraining) or ViLBERT, is then employed to learn the relationships between text and image segments. The training process involves contrastive learning, where positive pairs (correct text-image segment matches) are optimized for high similarity, while negative pairs are pushed apart. Loss functions like contrastive loss or triplet loss can be used for effective alignment. Evaluation metrics such as retrieval accuracy, IoU (Intersection over Union) for segmentation, and BLEU scores for textual coherence are utilized to measure performance.

Similarly, during preparation (e.g., training) of the optional image association MLM 124 to identify an image segment associated with the text chunks in the multimodal database and corresponding image for the identified image segment. The process begins with constructing a multimodal database 146 where nodes represent textual chunks and image segments, while edges capture their semantic relationships.

An optional image association training dataset containing images, segmented graphical elements, and associated text descriptions must be collected, ensuring proper annotation using tools like LabelMe or CVAT. If text is embedded within images, OCR techniques such as Tesseract or Google Vision API can be employed for extraction. In some aspects, the optional image association MLM 124 is trained on an optional image association training dataset 154 containing at least: (a) training images with image segments of regions of interests such that the image segments are labeled with text annotations describing what the image segment represents, (b) paired image-segment-text data to teach the image association MLM the relationship between image segments and the text annotations, and (c) ground truth labels for the training images and paired image-segment-text data to serve as a target output for the image association MLM. Additionally, graph embeddings can be used to represent textual and visual elements through graph neural networks (GNNs) or multimodal embedding techniques.

The training phase involves multiple steps. Image segmentation is first performed using deep learning models such as U-Net, Mask R-CNN, or DeepLabV3+, followed by feature extraction where image segments are converted into embeddings using architectures like ResNet, EfficientNet, or Vision Transformers (ViTs). Simultaneously, text chunks are processed into embeddings using transformer-based models like BERT, RoBERTa, or T5, and a Graph Neural Network (GNN) such as GraphSAGE or GAT is trained to learn the relationships between textual and visual elements. To align these modalities, a contrastive learning model like CLIP, ViLBERT, or ALIGN is trained to link image segment embeddings with text embeddings, leveraging loss functions such as triplet loss or contrastive loss to refine similarity matching.

Once trained, the model processes queries by converting user input into a text embedding using an LLM such as GPT, T5, or BERT. The multimodal database 146 is then searched using cosine similarity or nearest-neighbor search (e.g., FAISS) to find the most relevant text chunks and their associated image segments. The corresponding image is retrieved, and both the textual and visual context are fed into the LLM to generate an informative response. The model's performance is evaluated using metrics like precision, recall, and F1-score for text-image association, Intersection over Union (IoU) for image segment matching, and BLEU scores for text accuracy. A user feedback loop further refines the model by incorporating real-world queries and retraining on new data.

In some aspects, an optimizer such as Adam or SGD may be used to train the MLMs in the image segmentation MLM 120, the text segmentation MLM 122, and/or the optional image association MLM 124. In some aspects, the data may be split into training, validation, and test sets. In these aspects the image segmentation MLM 120, the text segmentation MLM 122, and/or the optional image association MLM 124 are trained on a respective training dataset (e.g., the image segmentation training dataset 150, the text segmentation training dataset 152, and/or the optional image association training dataset 154) and then validated by the validation sets to tune hyperparameters.

The computing device 108 may execute the annotation module 128 to generate text descriptions of the digital image and its image segments. In some aspects, the annotation module 128 may automate the annotation process by leveraging machine learning techniques, particularly LLMs, to generate textual descriptions that accurately represent the contents of both the overall image and the distinct segmented regions.

In some implementations, the annotation module 128 may utilize an LLM to analyze the digital image and its segmented parts, extracting meaningful descriptions based on visual features. The module may incorporate a vision-language model (e.g., CLIP, BLIP, or Flamingo) that can process both textual and visual inputs to generate natural language captions. The LLM can be fine-tuned on domain-specific datasets to improve its ability to describe particular graphical elements, ensuring the generated text is contextually relevant.

Additionally, in some aspects, the annotation module 128 may support interactive or automated refinement of annotations. For example, it could incorporate active learning, where human reviewers validate and correct generated annotations, enabling iterative model improvement. It could also employ attention-based mechanisms within transformer architectures to enhance the alignment between visual and textual representations, making the descriptions more accurate and meaningful.

Once the annotation module 128 successfully generates the text descriptions and segment associations, these annotations can be stored in the multimodal database 146, linking structured relationships between different graphical elements, their descriptions, and their semantic connections. This structured annotation process enhances downstream applications such as image retrieval, multimodal search, and intelligent question-answering systems that rely on accurate associations between text and image content.

The computing device 108 may execute the display module 130 to generate and display the image 102, the text 104, and/or the query 106 and display the response comprising the corresponding image with the annotated image segment from the RAG system 140. Generally, the display module 130 is responsible for managing and rendering the visual components of the user interface by handling the presentation of information to the user, ensuring that data and controls are displayed correctly and consistently across the UI.

In some aspects, the display module 130 is configured to render or draw all the elements of the UI, such as windows, buttons, text fields, menus, icons, images, and other components. In some aspects, the display module 130 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 130 may be considered the “view” part of a model-view-controller (MVC) or similar design pattern. It serves as the layer that presents data to the user and receives input to and from the computing device 108.

It should be noted that the collection, analysis, identification, and retrieval methods in the image segment association engine 110 and RAG system 140 are heavily simplified. One skilled in the art will appreciate that the engine(s) and/or the MLMs utilized may have significantly large datasets with highly specific details due to the complexity and scale of modern software systems. For example, the processes performed by the RAG system 140 with picture-segment-text connections cannot be feasibly replicated using pen and paper or the human mind due to limitations in cognitive capacity, memory, and processing speed. The system 100 leverages MLMS and/or LLMs to segment images, extract text relationships, and recognize patterns across large datasets—tasks that would be extremely slow and error-prone if performed manually.

Additionally, the system 100 employs a multimodal database 146 to store structured relationships between image segments and text chunks, enabling efficient retrieval that humans cannot match without extensive indexing and cross-referencing efforts. The system 100 also processes complex queries instantaneously, allowing users to locate specific image elements referenced in the text, a task that would require time-consuming manual scanning of entire documents if done by hand. Furthermore, its scalability allows it to handle thousands of pages and images simultaneously, whereas a human would be limited by cognitive load and fatigue. The system 100 also automates validation and error detection, making it highly effective for patent verification, compliance checks, and technical documentation review, tasks that would otherwise be prone to oversight and inaccuracies if done manually. Given the sheer complexity, scale, and speed required to efficiently link, retrieve, and verify image-text relationships, the AI-driven approach is not just beneficial but necessary for handling such tasks with accuracy and efficiency.

FIG. 2 is a block diagram illustrating a system for preparing machine learning models to generate image segments each depicting a distinct graphical element and identifying semantic links between related text chunks and image segments according to aspects of the present disclosure. As shown in example 200, the MLM training module 126 is configured to build and train specialized machine learning models with inference to perform particular tasks. This enables the specialized machine learning models to develop an ability to perform particular objectives on inputs that are not part of a training dataset (e.g., image segmentation training dataset 150, text segmentation training dataset 152 and/or the optional image association training dataset 154). By subjecting the specialized machine learning models to large amounts of unlabeled and/or labeled training data sets, the specialized machine learning models may perform particular tasks such as identifying graphical elements in a digital image, generating text chunks describing the graphical elements, and identifying semantic links between related chunks and image segments that are associated with a same distinct graphical elements.

Supervised learning is effective for tasks such as classification (assigning inputs to predefined categories) and regression (predicting continuous values) since it relies on the availability of labeled data for both training and evaluation phases. In supervised learning, the MLM training module 126 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the MLM training module 126 provides the algorithm with a training dataset including input-output pairs. The algorithm learns the mapping function that relates inputs to outputs through an iterative process, adjusting its internal parameters based on the provided examples.

During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 126 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM training module 126 includes at least a training database 213 configured to store the raw training data 219n and corresponding labels, a MLM database 156 to store the trained models (e.g., the prepared image segmentation MLM 120, the prepared text segmentation MLM 122, and/or the optional image association MLM 124). In some aspects, the MLM training module 126 may include an optional filtering ML module 229 and an optional filter module 217 configured to filter data from the training database 213 for training by removing poorly generated training data.

Training data from the image segmentation training dataset 150, the text segmentation training dataset 152, and the optional image association training dataset 154 is received into the MLM training module 126 via the training set generator 211. Details about the data included in each training dataset is described in more detail above with FIG. 1.

An optional filtering ML module 229 is configured to filter out bad training data to clean up the training data in the training dataset 219n. In some examples, the optional filter module 217 may be a neural network. In some examples, the optional filter module 217 is a mathematical model. In some examples, the cleaned training dataset 221n then undergoes optional preprocessing steps depending on which neural network or model is being trained.

The optional preprocess 1 223a, optional preprocess 2 223b, and the optional preprocess 223c are automated processes that modify the raw data received from 219n (or cleaned training dataset 221n) and prepare the raw data as input to the respective model trainers (e.g., image segmentation model trainer 225a, text segmentation model trainer 225b, and/or the optional image association model trainer 225c). These may be described in the MLM training module 126 as snippets of code that prepares the datasets. In some examples, the preprocessing module (e.g., preprocess 1 223a, preprocess 2 223b, preprocess 223c) for a particular trainer may be an automated script or code that will be set up the first time any model is trained.

The image segmentation model trainer 225a, the text segmentation model trainer 225b, and/or the optional image association model trainer 225c are the scripts or code that train the respective models. The image segmentation model trainer 225a, the text segmentation model trainer 225b, and/or the optional image association model trainer 225c may be a script or code that holds the instructions on how a model should be trained (e.g., optimization method, model architecture, dataset division, etc.) and also runs the training. The image segmentation model trainer 225a, the text segmentation model trainer 225b, and/or the optional image association model trainer 225c each take as input the raw or filtered processed training data and train the image segmentation model trainer 225a, the text segmentation model trainer 225b, and/or the optional image association model trainer 225c to achieve their specific objectives, respectively.

In summary, the raw dataset 219n or cleaned dataset 221n may optionally go through different preprocessing steps 223a, 223b, 223c and then a corresponding image segmentation model trainer 225a, the text segmentation model trainer 225b, and/or the optional image association model trainer 225c to generate a prepared image segmentation MLM 120, a prepared text segmentation MLM 122, and/or a prepared optional image association MLM 124. In some examples, each of these models may be a MLM or a neural network.

As a non-limiting example and as discussed above, the machine learning may be a neural network. The neural network models are designed using a set of hyperparameters that define high-level aspects of their architecture and training process. These hyperparameters include but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 219n used for training may include noise and bad training data from the training database 213. Accordingly, to create a clean and filtered training dataset, the optional filter module 217 is configured to filter out unwanted data points from the raw training dataset 219n by developing smaller, less accurate systems based on patterns and metadata information.

During the training process, the image segmentation model trainer 225a, the text segmentation model trainer 225b, and/or the optional image association model trainer 225c are presented with input data and labels of actual values, and the optimization objective, which aims to minimize the difference between the actual value and the predicted value, is calculated. The optimization algorithm updates the parameters of image segmentation model trainer 225a, the text segmentation model trainer 225b, and/or the optional image association model trainer 225c to reduce the value of the objective. This process is repeated for several iterations until the parameters do not change anymore. This process is repeated for various combinations of hyperparameters, and the model with the smallest label prediction error is selected as the final model.

When a new model (e.g., the prepared image segmentation MLM 120, the prepared text segmentation MLM 122, and/or the prepared optional image association MLM 124) is created, and a new process for filtering and automated labeling is established, it is added to the MLM database 156 in the MLM training module 126. This enables the new model to be part of the closed-loop model update process. Optionally, at regular intervals, data which is continuously collected can be filtered, labeled, and used to update old models by an optional filtering ML module 229. In some examples, the optional filtering ML module 229 is a neural network. In some examples, the optional filtering ML module 229 is a mathematical model. This approach may capture changes in the data over time.

FIG. 3 is an example flowchart for creating structured links between digital images, their image segments, and relevant text chunks according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). The method 300 describes a method of associating digital images and text.

The method begins by obtaining a digital image 102 and text 104 associated with the digital image 102. In some aspects, the digital image 102 may serve as a primary visual input, while the associated text 104 provides contextual or descriptive information related to the digital image 102.

A prepared image segmentation MLM 120 analyzes the digital image 102 to identify a plurality of image segments 301 in the digital image 102 and to generate a plurality of image segments 301 each depicting at least one distinct graphical element. The generated plurality of image segments 301 are then stored into the multimodal database 146 in the RAG system 140.

A LLM 311 may generate a text description 305 of the digital image 102 and generate descriptions of the image segments 301 of the image segments 301 for storage into the multimodal database 146.

A prepared text segmentation MLM 122 may split the text 104 associated with the digital image 102 into a plurality of text chunks 307 that each describe at least one distinct graphical element of the digital image 102. The plurality of text chunks 307 are stored in the multimodal database 146. In addition, the text segmentation MLM 122 may also analyze the plurality of image segments 301 and the text chunks 303 to identify semantic links 309 between related text chunks and image segments that describe and depict, respectively, the same one or more district graphic elements for storage into the multimodal database 146.

In this way, when a user enters a query 106 to a LLM from a LLM service provider network 142 in the RAG system 140, the process 300 may display a response comprising an image segment associated with text chunks in the multimodal database 146 and corresponding image for the identified image segment.

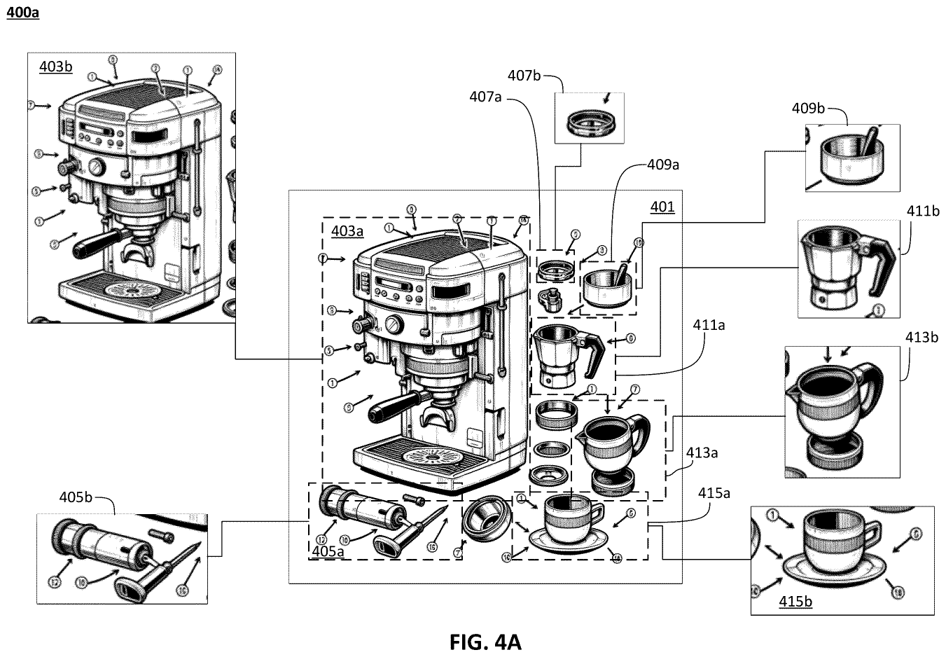

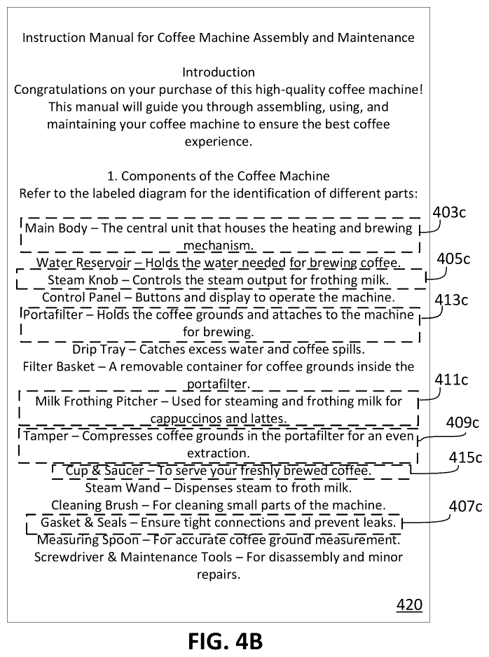

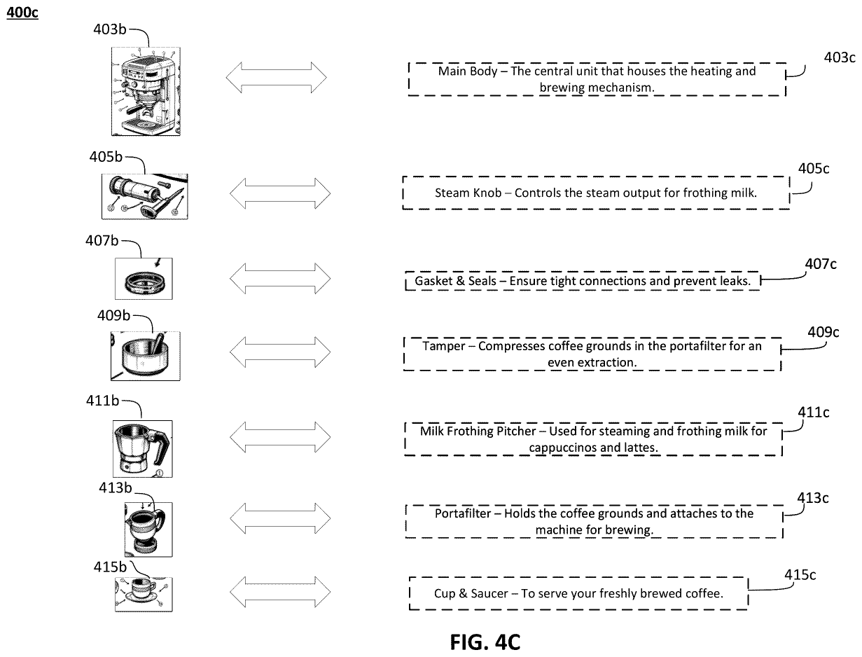

FIG. 4a is an example of a digital image with identified plurality of distinct graphical elements according to aspects of the present disclosure. FIG. 4a shows a digital image 401 of a coffee machine in a disassembled state in an exploded view. As shown in example 400a, the digital image 401 corresponds to a coffee machine in an exploded view showing at least a main body 403a, a steam knob 405a, a gasket 407a, a tamper 409a, a milk frothing pitcher 411a, a portafilter 413a, a cup & saucer 415c.

The digital image 401 is analyzed using an image segmentation MLM to generate a plurality of image segments 403b, 405b, 407b, 409b, 411b, 413b, 415b each depicting at least one distinct graphical element 403a, 405a, 407a, 409a, 411a, 413a, 415a. In some aspects, the image segmentation MLM generates a plurality of image segments for each identified graphical element. As shown in example 400a, an image segment 403b of the main body 403a, an image segment 405b of the steam knob 405a, an image segment 407b of a gasket 407a, an image segment 409b of the tamper 409a, an image segment 411b of the milk frothing pitcher 411a, an image segment 413b of the portafilter 413a, and an image segment 415b of the cup & saucer 415c.

FIG. 4b is an example of text corresponding to a digital image split into text chunks describing a graphical element of the digital image according to aspects of the present disclosure. As shown in example 400b, the text 420 is associated with the digital image 401 and corresponds to an instruction manual for a coffee machine assembly and maintenance.

The text 420 is analyzed using a text segmentation MLM to generate image segments each depicting a distinct graphical element in the digital image 401. As shown in example 400b, the text 420 is split into at least a first text chunk 403c describing a main body 403a, a second text chunk 405c describing a steam knob 405a, a third text chunk 407c describing a gasket & seal 407a, a fourth text chunk 409c describing a tamper 409a, a fifth text chunk 411c describing a milk frothing pitcher 411a, a sixth text chunk 413c describing a portafilter 413a, and a seventh text chunk 415c describing a cup & saucer 415a.

In some aspects the text segmentation MLM may analyze the plurality of image segments (e.g., image segment 403b of the main body 403a, an image segment 405b of the steam knob 405a, an image segment 407b of a gasket 407a, an image segment 409b of the tamper 409a, an image segment 411b of the milk frothing pitcher 411a, an image segment 413b of the portafilter 413a, and an image segment 415b of the cup & saucer 415c) and the text chunks (e.g., a first text chunk 403c describing a main body 403a, a second text chunk 405c describing a steam knob 405a, a third text chunk 407c describing a gasket & seal 407a, a fourth text chunk 409c describing a tamper 409a, a fifth text chunk 411c describing a milk frothing pitcher 411a, a sixth text chunk 413c describing a portafilter 413a, and a seventh text chunk 415c describing a cup & saucer 415a) to identify semantic links between related text chunks and image segments.

In some aspects, the digital image 401, plurality of image segments 403b, 405b, 407b, 409b, 411b, 413b, 415b, the plurality of text chunks 403c, 405c, 407c, 409c, 411c, 413c, 415c and the semantic links between the related text chunks and the image segments are stored in a multimodal database.

FIG. 4c is an example of semantic links between related text chunks and image segments according to aspects of the present disclosure. As shown in example 400c, each text chunk may be associated with an image segment that describe and depict, respectively, the same one or more distinct graphic elements.

This process leverages machine learning models to segment text into meaningful chunks while concurrently segmenting images into distinct regions, facilitating a comparative analysis that aligns descriptive text with depicted visual elements. As shown in example 400c, an image segment 403b of the main body 403a corresponds to a first text chunk 403c describing a main body 403a; an image segment 405b of the steam knob 405 corresponds to a second text chunk 405c describing a steam knob 405a; an image segment 407b of a gasket 407a corresponds to a third text chunk 407c describing a gasket & seal 407a; an image segment 409b of the tamper 409a corresponds to a fourth text chunk 409c describing a tamper 409a; an image segment 411b of the milk frothing pitcher 411a corresponds to a fifth text chunk 411c describing a milk frothing pitcher 411a; an image segment 413b of the portafilter 413a corresponds to a sixth text chunk 413c describing a portafilter 413a; and an image segment 415b of the cup & saucer 415c corresponds to a seventh text chunk 415c describing a cup & saucer 415a. By mapping these associations, the approach enhances multimodal understanding, ensuring that corresponding text chunks and image segments are semantically linked to improve interpretation, retrieval, and generation of contextually relevant information across both modalities.

FIG. 5 is an example method for associating digital images and text according to an aspect of the present disclosure. In various implementations, the method 500 is performed by a device with one or more processors and non-transitory memory that performs intent prediction. In some implementations, the method 500 is performed by processing logic, including hardware, firmware, software, or a combination thereof. In some implementations, the method 500 is performed by a processor executing code stored in a non-transitory computer-readable medium (e.g., a memory). The method 500 describes a method of associating digital images and text.

At 501, the method 500 may include obtaining a digital image and text associated with the digital image.

In some aspects, the method may include generating text descriptions of the digital image and the image segments using a LLM, and storing the text descriptions of the digital image and the image segments in a multimodal database.

In some aspects, the multimodal may correspond to a graph database. Multimodal databases are designed to store and manage diverse data types, including text, images, audio, video, and structured data. Various database models support multimodal storage, each suited to different use cases. Graph databases like Neo4j and ArangoDB excel at capturing relationships between different data types, while document-oriented databases such as MongoDB and CouchDB allow flexible storage of multimedia within JSON or BSON formats. Multimodal databases, including Oracle Multimodel and Microsoft Azure Cosmos DB, natively support multiple data models, making them ideal for complex applications. Vector databases like Pinecone and FAISS specialize in storing high-dimensional vector embeddings from AI models for image and text retrieval, whereas time-series databases such as InfluxDB and TimescaleDB are optimized for storing sequential data like sensor logs and timestamped multimedia. Traditional relational databases (PostgreSQL, MySQL) support Binary Large Objects (BLOBs) to store multimedia files alongside structured data. Meanwhile, key-value stores like Redis and DynamoDB efficiently manage multimodal data by associating keys with large binary objects, making them useful for caching and retrieval. Additionally, hybrid databases like Apache Cassandra and MarkLogic integrate relational, document, and graph storage capabilities, offering flexibility for complex multimodal applications. The choice of database depends on the specific requirements of data retrieval, scalability, and integration with AI-driven applications.

At 503, the method 500 may include analyzing the digital image using an image segmentation MLM trained to identify a plurality of distinct graphical elements in the digital image and to generate a plurality of image segments each depicting at least one distinct graphical element.

At 505, the method 500 may include splitting the text associated with the digital image using a text segmentation MLM into a plurality of text chunks each describing at least one distinct graphical element of the digital image.

At 507, the method 500 may include analyzing the plurality of image segments and the plurality of text chunks using the text segmentation MLM to identify semantic links between related text chunks and image segments that describe and depict, respectively, the same one or more district graphic elements.

At 509, the method 500 may include storing, into the database, the digital image, the plurality of image segments, the plurality of text chunks, and the semantic links between the related text chunks and image segments.

In some aspects, the database is used by a RAG LLM.

In some aspects, the method 500 may further include: receiving an input query to a LLM service from a user; transmitting a prompt based on the input query to the LLM service; obtaining a response from the LLM service by utilizing an image association MLM to identify an image segment associated with the text chunks in the database and corresponding image for the identified image segment; annotating the identified image segment associated with the text chunk; and display the response comprising the corresponding image with the annotated image segment.

In some aspects, the method 500 may further include obtaining a validation digital image containing reference numbers and text; generating validation image segments from the reference image using the image segmentation MLM; splitting the text associated with the validation image into text phrases and associating the text phrases to a respective validation image segment using the text segmentation MLM; storing the validation image, the validation image segments, the text phrases, and the semantic links between the text phrases, corresponding validation image segments, and the validation image into the database of a RAG system; obtaining an input query checking for inconsistencies in reference numbers in the validation image and the text to a LLM service; transmitting a prompt based on the input query to the LLM service; obtaining a response from the LLM service by utilizing an image LLM to identify an image segment associated with the text in the database and corresponding image for the identified image segment; comparing the response from the LLM service with the text phrases generated from the text segmentation MLM; and displaying results of the comparison between the response from the LLM service with the text phrases generated from the text segmentation MLM.

In some aspects, the method 500 may further include training the image segmentation MLM by: (1) providing, to the image segmentation MLM, an image segmentation training dataset comprising at least one of: (a) training images labeled and annotated with multiple image segments, and (b) ground truth labels for the training images to serve as a target output for the image segmentation MLM, and (2) preparing the image segmentation MLM using the provided image segmentation training dataset.

In some aspects, the method 500 may further include training the text segmentation MLM by: (1) providing, to the text segmentation MLM, a text segmentation training dataset comprising at least one of: (a) training data labeled and annotated with text input segmented into text phrases and linked to specific image segments, (b) corresponding image data segmented into image segments that match the text phrases, and (c) ground truth labels for the training data and corresponding image data to serve as a phrase-segment mapping for the text segmentation MLM, and (2) preparing the text segmentation MLM using the provided text segmentation training dataset.

In some aspects, the method 500 may further include training the image association MLM by: (1) providing, to the image association MLM, an image association training dataset comprising at least one of: (a) training images with image segments of regions of interests such that the image segments are labeled with text annotations describing what the image segment represents, (b) paired image-segment-text data to teach the image association MLM the relationship between image segments and the text annotations, and (c) ground truth labels for the training images and paired image-segment-text data to serve as a target output for the image association MLM, and (2) preparing the image association MLM using the provided image association training dataset.

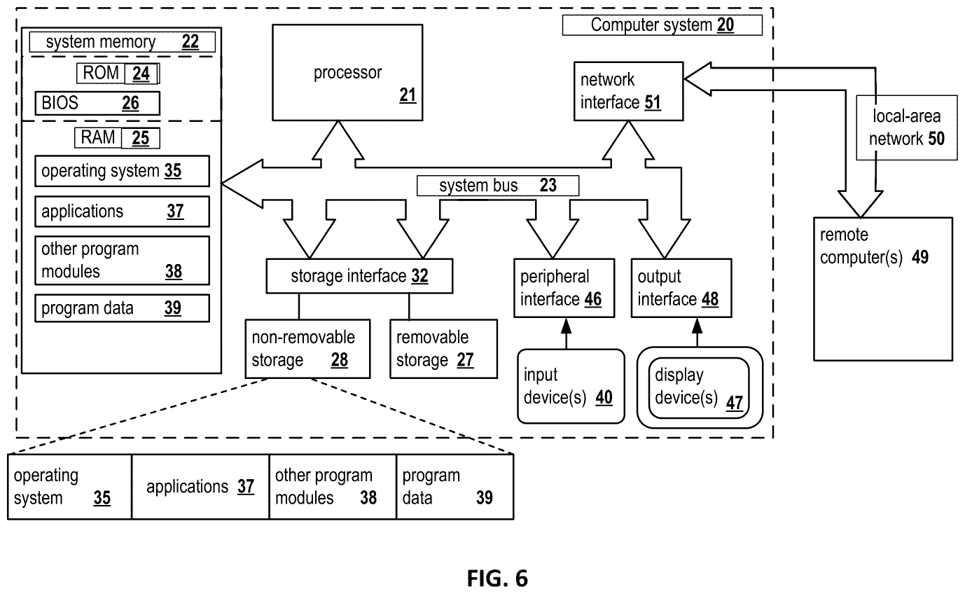

FIG. 6 presents an example of a general-purpose computer system on which aspects of the present disclosure can be implemented.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for associating digital images and text, comprising:
obtaining a digital image and text associated with the digital image;
analyzing the digital image using an image segmentation machine learning model (MLM) trained to identify a plurality of distinct graphical elements in the digital image and to generate a plurality of image segments each depicting at least one distinct graphical element;
splitting the text associated with the digital image using a text segmentation MLM into a plurality of text chunks each describing at least one distinct graphical element of the digital image;
analyzing the plurality of image segments and the plurality of text chunks using the text segmentation MLM to identify semantic links between related text chunks and image segments that describe and depict, respectively, the same one or more district graphic elements; and
storing, into a multimodal database, the digital image, the plurality of image segments, the plurality of text chunks, and the semantic links between the related text chunks and image segments.

2. The method of claim 1, further comprising:
generating text descriptions of the digital image and the image segments using a LLM; and
storing the text descriptions of the digital image and the image segments in the multimodal database.

3. The method of claim 1, wherein the multimodal database is used by a retrieval-augmented generation (RAG) LLM.

4. The method of claim 3, further comprising:
receiving an input query to a LLM service from a user;
transmitting a prompt based on the input query to the LLM service;
obtaining a response from the LLM service by utilizing an image association MLM to identify an image segment associated with the text chunks in the multimodal database and corresponding image for the identified image segment;
annotating the identified image segment associated with the text chunk; and
display the response comprising the corresponding image with the annotated image segment.

5. The method of claim 3, further comprising:
obtaining a validation digital image containing reference numbers and text;
generating validation image segments from the reference image using the image segmentation MLM;
splitting the text associated with the validation image into text phrases and associating the text phrases to a respective validation image segment using the text segmentation MLM;
storing the validation image, the validation image segments, the text phrases, and the semantic links between the text phrases, corresponding validation image segments, and the validation image into the multimodal database of a RAG system;
obtaining an input query checking for inconsistencies in reference numbers in the validation image and the text to a LLM service;
transmitting a prompt based on the input query to the LLM service;
obtaining a response from the LLM service by utilizing an image LLM to identify an image segment associated with the text in the multimodal database and corresponding image for the identified image segment;
comparing the response from the LLM service with the text phrases generated from the text segmentation MLM; and
displaying results of the comparison between the response from the LLM service with the text phrases generated from the text segmentation MLM.

6. The method of claim 1, further comprising: training the image segmentation MLM by:
(1) providing, to the image segmentation MLM, an image segmentation training dataset comprising at least one of:
(a) training images labeled and annotated with multiple image segments, and
(b) ground truth labels for the training images to serve as a target output for the image segmentation MLM, and
(2) preparing the image segmentation MLM using the provided image segmentation training dataset.

7. The method of claim 1, further comprising: training the text segmentation MLM by:
(1) providing, to the text segmentation MLM, a text segmentation training dataset comprising at least one of:
(a) training data labeled and annotated with text input segmented into text phrases and linked to specific image segments,
(b) corresponding image data segmented into image segments that match the text phrases, and
(c) ground truth labels for the training data and corresponding image data to serve as a phrase-segment mapping for the text segmentation MLM, and
(2) preparing the text segmentation MLM using the provided text segmentation training dataset.

8. The method of claim 1, further comprising: training the image association MLM by:
(1) providing, to the image association MLM, an image association training dataset comprising at least one of:
(a) training images with image segments of regions of interests such that the image segments are labeled with text annotations describing what the image segment represents,
(b) paired image-segment-text data to teach the image association MLM the relationship between image segments and the text annotations, and
(c) ground truth labels for the training images and paired image-segment-text data to serve as a target output for the image association MLM, and
(2) preparing the image association MLM using the provided image association training dataset.

9. A system for associating digital images and text, comprising:
at least one memory; and
at least one hardware processor coupled with the at least one memory and configured, individually or in combination, to:
obtain a digital image and text associated with the digital image;
analyze the digital image using an image segmentation machine learning model (MLM) trained to identify a plurality of distinct graphical elements in the digital image and to generate a plurality of image segments each depicting at least one distinct graphical element;
split the text associated with the digital image using a text segmentation MLM into a plurality of text chunks each describing at least one distinct graphical element of the digital image;
analyze the plurality of image segments and the plurality of text chunks using the text segmentation MLM to identify semantic links between related text chunks and image segments that describe and depict, respectively, the same one or more district graphic elements; and
store into a multimodal database the digital image, the plurality of image segments, the plurality of text chunks, and the semantic links between the related text chunks and image segments.

10. The system of claim 9, wherein the at least one hardware processor is coupled with the at least one memory and configured, individually or in combination, to:
generate text descriptions of the digital image and the image segments using a LLM; and
store the text descriptions of the digital image and the image segments in the multimodal database.

11. The system of claim 9, wherein the multimodal database is used by a retrieval-augmented generation (RAG) LLM.

12. The system of claim 11, wherein the least one hardware processor is coupled with the at least one memory and configured, individually or in combination, to:
receive an input query to a LLM service from a user;
transmit a prompt based on the input query to the LLM service;
obtain a response from the LLM service by utilizing an image association MLM to identify an image segment associated with the text chunks in the multimodal database and corresponding image for the identified image segment;
annotate the identified image segment associated with the text chunk; and
display the response comprising the corresponding image with the annotated image segment.

13. The system of claim 11, wherein the least one hardware processor is coupled with the at least one memory and configured, individually or in combination, to:
obtain a validation digital image containing reference numbers and text;
generate validation image segments from the reference image using the image segmentation MLM;
split the text associated with the validation image into text phrases and associating the text phrases to a respective validation image segment using the text segmentation MLM;
store the validation image, the validation image segments, the text phrases, and the semantic links between the text phrases, corresponding validation image segments, and the validation image into the multimodal database of a RAG system;
obtain an input query checking for inconsistencies in reference numbers in the validation image and the text to a LLM service;
transmit a prompt based on the input query to the LLM service;
obtain a response from the LLM service by utilizing an image LLM to identify an image segment associated with the text in the multimodal database and corresponding image for the identified image segment;
compare the response from the LLM service with the text phrases generated from the text segmentation MLM; and
display results of the comparison between the response from the LLM service with the text phrases generated from the text segmentation MLM.

14. The system of claim 9, wherein the least one hardware processor is coupled with the at least one memory and configured, individually or in combination, to:
train the image segmentation MLM by:
(1) providing, to the image segmentation MLM, an image segmentation training dataset comprising at least one of:
(a) training images labeled and annotated with multiple image segments, and
(b) ground truth labels for the training images to serve as a target output for the image segmentation MLM, and
(2) preparing the image segmentation MLM using the provided image segmentation training dataset.

15. The system of claim 9, wherein the least one hardware processor is coupled with the at least one memory and configured, individually or in combination, to:
train the text segmentation MLM by:
(1) providing, to the text segmentation MLM, a text segmentation training dataset comprising at least one of:
(a) training data labeled and annotated with text input segmented into text phrases and linked to specific image segments,
(b) corresponding image data segmented into image segments that match the text phrases, and
(c) ground truth labels for the training data and corresponding image data to serve as a phrase-segment mapping for the text segmentation MLM, and
(2) preparing the text segmentation MLM using the provided text segmentation training dataset.

16. The system of claim 9, wherein the least one hardware processor is coupled with the at least one memory and configured, individually or in combination, to:
train the image association MLM by:
(1) providing, to the image association MLM, an image association training dataset comprising at least one of:
(a) training images with image segments of regions of interests such that the image segments are labeled with text annotations describing what the image segment represents,
(b) paired image-segment-text data to teach the image association MLM the relationship between image segments and the text annotations, and
(c) ground truth labels for the training images and paired image-segment-text data to serve as a target output for the image association MLM, and
(2) preparing the image association MLM using the provided image association training dataset.

17. A non-transitory computer readable medium storing thereon computer executable instructions for associating digital images and text, including instructions for:
obtaining a digital image and text associated with the digital image;
analyzing the digital image using an image segmentation machine learning model (MLM) trained to identify a plurality of distinct graphical elements in the digital image and to generate a plurality of image segments each depicting at least one distinct graphical element;
splitting the text associated with the digital image using a text segmentation MLM into a plurality of text chunks each describing at least one distinct graphical element of the digital image;
analyzing the plurality of image segments and the plurality of text chunks using the text segmentation MLM to identify semantic links between related text chunks and image segments that describe and depict, respectively, the same one or more district graphic elements; and
storing into a multimodal database the digital image, the plurality of image segments, the plurality of text chunks, and the semantic links between the related text chunks and image segments.

18. The non-transitory computer readable medium of claim 17, further including instructions for: including instructions for:
generating text descriptions of the digital image and the image segments using an LLM; and
storing the text descriptions of the digital image and the image segments in the multimodal database.

19. The non-transitory computer readable medium of claim 17, wherein the multimodal database is used by a retrieval-augmented generation (RAG) LLM.

20. The non-transitory computer readable medium of claim 17, including instructions for:
receiving an input query to a LLM service from a user;
transmitting a prompt based on the input query to the LLM service;
obtaining a response from the LLM service by utilizing an image association MLM to identify an image segment associated with the text chunks in the multimodal database and corresponding image for the identified image segment;
annotating the identified image segment associated with the text chunk; and
displaying the response comprising the corresponding image with the annotated image segment.
